(19) United States
(12) Patent Application Publication
(10) Pub. No.: US 2018/0195640 A1
(43) Pub. Date: Jul. 12, 2018

(54) SOLENOID VALVE

(71) Applicant: KYB CORPORATION, Tokyo (JP)

(72) Inventor: Toru TAKEUCHI, Kanagawa (JP)

(73) Assignee: KYB Corporation, Tokyo (JP)

(21) Appl. No.: 15/740,534

(22) PCT Filed: Jul. 8, 2016
(86) PCT No.: PCT/JP2016/070322

§ 371 Date: Dec. 28, 2017

(30) Foreign Application Priority Data
Jul. 15, 2015 (JP) 2015-141227

(51) Int. Cl. F16K 47/04; F16K 3/26; F16K 3/34; F16K 31/40

(52) U.S. Cl. CPC F16K 47/04; F16K 3/267; F16K 3/265; F16K 31/408; F16K 3/34

(57) ABSTRACT

A solenoid valve includes a main valve that controls a flow rate of a working fluid, a sleeve in which the main valve is slidably inserted, and a solenoid unit that displaces the main valve. The sleeve includes a slide support and a large-diameter portion. The main valve is slidably supported by the slide support. The large-diameter portion is closer to an open end of the insertion hole than the slide support is, and has a diameter larger than an outer diameter of the slide support. The sleeve is fixed inside the insertion hole by causing the large-diameter portion to be pushed against the valve block by the solenoid unit.

### TECHNICAL FIELD

The present invention relates to a solenoid valve.

### BACKGROUND ART

Hydraulically operated construction machines and industrial machines commonly use a solenoid valve that controls a flow rate of working oil in accordance with an electromagnetic force.

JP 2007-239996A describes a solenoid valve including a cylindrical sleeve and a poppet valve that is slidably inserted in the sleeve. A tip of an inner circumference of the sleeve is provided with a seat that allows the poppet valve to be seated thereon.

### SUMMARY OF INVENTION

When the solenoid valve disclosed in JP 2007-239996A is fixedly inserted in an insertion hole provided in a valve block, a tip portion of the sleeve is pushed against the valve block. The load attributed to this pushing action applies compressive stress to the sleeve including the seat, thereby causing the sleeve to slightly deform as a whole. This could possibly cause the occurrence of operational defects, such as the inability of the poppet valve that slides inside the sleeve to move smoothly, and a decline in the sealing performance between the poppet valve and the seat.

The present invention aims to prevent operational defects of a valve body that slides inside a sleeve in a solenoid valve that is fixedly inserted in an insertion hole provided in a valve block.

According to one aspect of the present invention, a solenoid valve fixedly inserted in an insertion hole provided in a valve block is provided. The solenoid valve includes: a valve body configured to control a flow rate of a working fluid flowing through a passage provided inside the valve block; a hollow cylindrical sleeve configured to allow the valve body to be slidably inserted therein; and a solenoid unit configured to displace the valve body in an axial direction. The sleeve includes a slide support and a large-diameter portion, the slide support being configured to slidably support the valve body, the large-diameter portion being provided so as to be closer to an open end of the insertion hole than the slide support and being configured to have a diameter larger than an outer diameter of the slide support. The solenoid unit is adjacent to the large-diameter portion. The sleeve is fixed inside the insertion hole by causing the large-diameter portion to be pushed against the valve block by the solenoid unit.

### BRIEF DESCRIPTION OF DRAWINGS

FIG. 1 is a cross-sectional view of a solenoid valve according to an embodiment of the present invention.

### DESCRIPTION OF EMBODIMENTS

The following describes an embodiment of the present invention with reference to the attached drawing.

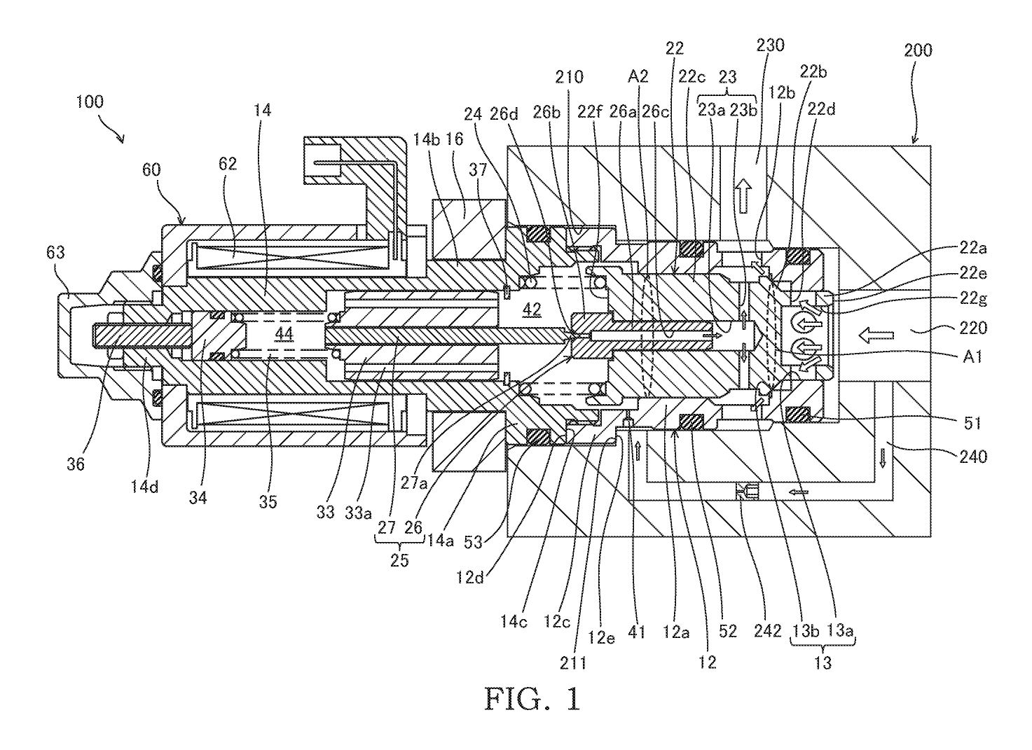

A solenoid valve 100 according to the embodiment of the present invention will now be described with reference to FIG. 1. The solenoid valve 100 is provided in construction machines, industrial machines, and so forth to control a flow rate of a working fluid supplied from a non-illustrated fluid pressure source to an actuator (load), and a flow rate of a working fluid discharged from the actuator to, for example, a working fluid tank.

The solenoid valve 100 shown in FIG. 1 is fixedly inserted in a non-penetrating insertion hole 210 provided in a valve block 200. The valve block 200 has an inlet passage 220 and an outlet passage 230. One end of the inlet passage 220 opens to a bottom surface of the insertion hole 210. The other end of the inlet passage 220 opens to an outer surface of the valve block 200, and is connected to the fluid pressure source via, for example, a non-illustrated pipe. One end of the outlet passage 230 opens to a side surface of the insertion hole 210. The other end of the outlet passage 230 opens to an outer surface of the valve block 200, and is connected to the actuator via, for example, a non-illustrated pipe.

In the solenoid valve 100, working oil is used as the working fluid. As indicated by arrows in FIG. 1, working oil flows from the inlet passage 220 to the outlet passage 230. The working fluid is not limited to working oil, and may be another incompressible fluid or compressible fluid.

The solenoid valve 100 includes a main valve 22, a hollow cylindrical sleeve 12 in which the main valve 22 is slidably inserted, and a solenoid unit 60 that displaces the main valve 22 in an axial direction. The main valve 22 serves as a valve body that controls a flow rate of working oil supplied to the actuator via the inlet passage 220 and the outlet passage 230 provided inside the valve block 200.

The sleeve 12 includes a slide support 12a, a large-diameter portion 12c, and a seat 13. Inside the insertion hole 210, an outer circumferential surface of the main valve 22 is slidably supported by the slide support 12a. The large-diameter portion 12c is closer to an open end of the insertion hole 210 than the slide support 12a is, and has a diameter larger than an outer diameter of the slide support 12a. The seat 13 is located at the side of the slide support 12a opposite to the large-diameter portion 12c, and allows the main valve 22 to be seated thereon.

The large-diameter portion 12c has an outer flat end surface 12d located near the open end of the insertion hole 210, and an inner flat end surface 12e located near the slide support 12a. The large-diameter portion 12c has a flange-like shape. The insertion hole 210 has a step portion 211 that opposes the inner flat end surface 12e. The sleeve 12 is fixed inside the insertion hole 210 by causing the inner flat end surface 12e of the large-diameter portion 12c to be pushed against the step portion 211. The large-diameter portion 12c is not limited to having a flange-like shape, and may have any shape as long as it has a part that radially projects more outward than the outer diameter of the slide support 12a.

The seat 13 includes two seat portions: a first seat portion 13a that forms a circular hole and enables communication between a space inside the sleeve 12 and the inlet passage 220 of the valve block 200, and a second seat portion 13b that forms a circular truncated cone and is located downstream relative to the first seat portion 13a. The first seat portion 13a, the second seat portion 13b, and the sleeve 12 are disposed to share the same central line.

A plurality of communication holes 12b that enable communication between the space inside the sleeve 12 and the outlet passage 230 of the valve block 200 are provided at circumferential intervals between the second seat portion 13b and the slide support 12a.

An O-ring 51 and an O-ring 52 are mounted on an outer circumference of the seat 13 and an outer circumference of the slide support 12a, respectively, with the communication holes 12b interposed therebetween. The site of connection between the communication holes 12b and the outlet passage 230 is sealed by the O-rings 51, 52 that are compressed between the sleeve 12 and the insertion hole 210. Therefore, only working oil that has passed through the communication holes 12b of the sleeve 12 is supplied to the outlet passage 230.

The main valve 22 is a columnar member that is inserted in the sleeve 12 in such a manner that one end surface 22e is located near the seat 13, the other end surface 22f is located near the large-diameter portion 12c, and a tube portion 22c is slidably supported by the slide support 12a.

The other end surface 22f of the main valve 22 faces a pilot pressure chamber 42 defined by the main valve 22, the sleeve 12, and the solenoid unit 60.

The sleeve 12 that defines a part of the pilot pressure chamber 42 has a lead-in hole 41 that opens to the pilot pressure chamber 42. A passage 240 is provided in the valve block 200. The passage 240 communicates with the inlet passage 220 at one end, and communicates with the pilot pressure chamber 42 at the other end via the lead-in hole 41. Therefore, high-pressure working oil supplied to the inlet passage 220 is directed to the pilot pressure chamber 42 via the passage 240 and the lead-in hole 41.

The passage 240 is provided with an orifice 242 that imparts resistance to working oil flowing through the passage 240. The orifice 242 limits the inflow of working oil to the pilot pressure chamber 42. The orifice is not limited to being provided in the passage 240, and may be provided in the lead-in hole 41. The passage 240 may be provided with a check valve that prevents working oil led to the pilot pressure chamber 42 from flowing back to the inlet passage 220.

A main return spring 24 is provided inside the pilot pressure chamber 42. The main return spring 24 is locked to the other end surface 22f at one end, and locked to the solenoid unit 60 at the other end.

A biasing force of the main return spring 24 acts in a direction of closing the main valve 22. The pressure of working oil supplied to the inlet passage 220 acts on a valve-opening pressure receiving surface A1 that is equivalent to a cross-section of the second seat portion 13b of the main valve 22, thereby acting in a direction of opening the main valve 22. The pressure of working oil inside the pilot pressure chamber 42 acts on a valve-closing pressure receiving surface A2 that is equivalent to a cross-section of the tube portion 22c, thereby acting in the direction of closing the main valve 22. Therefore, the main valve 22 is displaced in the direction of opening the main valve 22 when a thrust attributed to the pressure of working oil that is supplied to the inlet passage 220 and acts on the valve-opening pressure receiving surface A1 exceeds a net force obtained from a thrust attributed to the pressure of working oil that is present inside the pilot pressure chamber 42 and acts on the valve-closing pressure receiving surface A2 and from the biasing force of the main return spring 24. On the other hand, the main valve 22 is displaced in the direction of closing the main valve 22 when the thrust attributed to the pressure of working oil that is supplied to the inlet passage 220 and acts on the valve-opening pressure receiving surface A1 falls below the net force.

The main valve 22 has a columnar spool valve 22a that is located near the inlet passage 220 and slidably inserted in the first seat portion 13a. The main valve 22 also has a poppet valve 22b that is located between the spool valve 22a and the tube portion 22c, can be seated on the second seat portion 13b, and forms a circular truncated cone.

A recess 22g that communicates with the inlet passage 220 is provided on one end surface 22e of the main valve 22 so as to be coaxial with the spool valve 22a. A plurality of through holes 22d are provided at circumferential intervals in the spool valve 22a. One end of each through hole 22d opens to a surface that slides on the first seat portion 13a. The other end of each through hole 22d opens to an inner circumferential surface of the recess 22g.

Each through hole 22d is gradually opened at the downstream end of the first seat portion 13a as the spool valve 22a moves in a direction of separating the poppet valve 22b from the second seat portion 13b. That is, an exposed opening area of each through hole 22d is created by separation from the first seat portion 13a, and changes in accordance with an amount of movement of the spool valve 22a. Such a change in the opening area of each through hole 22d enables control of a flow rate of working oil supplied to the outlet passage 230.

Each through hole 22d is arranged in such a manner that it is not completely closed by the first seat portion 13a even when the poppet valve 22b is in contact with the second seat portion 13b. That is, the opening area of each through hole 22d has the smallest value at a valve-closing position where the poppet valve 22b is in contact with the second seat portion 13b, and gradually increases as the poppet valve 22b is displaced in a direction of closing the poppet valve 22b.

Each through hole 22d may be arranged in such a manner that it is closed by the first seat portion 13a until the poppet valve 22b moves away from the second seat portion 13b to a certain extent. In this case, a flow rate of working oil can be set to almost zero until the main valve 22 is displaced to a certain extent.

The main valve 22 also includes a communication passage 23 that enables communication between the pilot pressure chamber 42 and the outlet passage 230, and a pilot pressure control valve 25 that controls the pressure inside the pilot pressure chamber 42 by adjusting the state of communication between the pilot pressure chamber 42 and the communication passage 23.

The communication passage 23 is composed of a non-penetrating first communication passage 23a that extends from the other end surface 22f of the main valve 22 along the axial direction, and second communication passages 23b that radially extend from the first communication passage 23a and open to the outer circumferential surface of the main valve 22. The second communication passages 23b are arranged in such a manner that they always communicate with the communication holes 12b in the range of displacement of the main valve 22 in the axial direction.

The pilot pressure control valve 25 includes a hollow cylindrical sleeve 26 provided with a sub seat 26d, and a cylindrical sub valve 27. One end of the sub valve 27 has a sub poppet valve 27a that can be seated on the sub seat 26d.

The sleeve 26 has a press-fit portion 26a that is press-fit into the first communication passage 23a, a large-diameter portion 26b that faces the pilot pressure chamber 42 and is larger in outer diameter than the press-fit portion 26a, and a through hole 26c that penetrates the large-diameter portion 26b and the press-fit portion 26a in the axial direction. The sleeve 26 is fixedly fit to the main valve 22 via the press-fit portion 26a. Alternatively, the press-fit portion 26a and the first communication passage 23a may be provided with threaded portions, and the sleeve 26 may be screwed to the main valve 22. Alternatively, the sleeve 26 and the main valve 22 may be integrated. When the sleeve 26 and the main valve 22 are provided as separate members, a passage provided in each of them can easily be processed. Furthermore, sleeves 26 that differ in, for example, the shape of the sub seat 26d can be attached to the main valve 22; thus, for example, only the specifications of the pilot pressure control valve 25 can be changed while using a common main valve 22.

The sub seat 26d is provided at an open end of the through hole 26c that opens to the large-diameter portion 26b. Therefore, the first communication passage 23a and the pilot pressure chamber 42 communicate with each other via the sub seat 26d and the through hole 26c.

When the sub poppet valve 27a is separated from the sub seat 26d, a gap is created between the sub poppet valve 27a and the sub seat 26d, and working oil inside the pilot pressure chamber 42 is discharged from this gap to the outlet passage 230 via the through hole 26c, the communication passage 23, and the communication holes 12b. Although working oil is directed to the pilot pressure chamber 42 via the passage 240, as the orifice 242 provided in the passage 240 limits the inflow of working oil to the pilot pressure chamber 42, the pressure inside the pilot pressure chamber 42 decreases in consequence.

The size of the gap between the sub poppet valve 27a and the sub seat 26d is adjusted by changing a position of the sub valve 27 in the axial direction relative to the sleeve 26. The solenoid unit 60 controls the position of the sub valve 27 in the axial direction. That is, the solenoid unit 60 controls the size of this gap.

The solenoid unit 60 includes a cylindrical solenoid tube 14 connected to the sleeve 12, a plunger 33 that is slidably housed in the solenoid tube 14 and joined to the sub valve 27, and a coil 62 provided outside the solenoid tube 14.

The solenoid tube 14 includes an insertion portion 14a that is inserted in the insertion hole 210 of the valve block 200, and a small-diameter portion 14b that is smaller in outer diameter than the insertion potion 14a and disposed outside the insertion hole 210 so as to be adjacent to the insertion portion 14a.

The insertion portion 14a has a flat end surface 14c located near the sleeve 12. The flat end surface 14c opposes the outer flat end surface 12d of the large-diameter portion 12c of the sleeve 12. Once the solenoid tube 14 has been screwed to the sleeve 12, the flat end surface 14c and the outer flat end surface 12d are in surface contact with each other. Accordingly, the pilot pressure chamber 42, which serves as a space provided inside the solenoid tube 14 and the sleeve 12, is sealed, thereby preventing working oil inside the pilot pressure chamber 42 from leaking to the outside via the site of connection between the solenoid tube 14 and the sleeve 12. The connection between the solenoid tube 14 and the sleeve 12 may be established by fitting them to each other, rather than by screwing them to each other.

An O-ring 53 serving as a seal member is mounted on an outer circumference of the insertion portion 14a. The O-ring 53, which is compressed between the solenoid tube 14 and the insertion hole 210, blocks communication between the interior of the insertion hole 210 and the outside. This can not only prevent working oil inside the insertion hole 210 from leaking to the outside, but also prevent external water, dust, and so forth from entering the interior of the insertion hole 210.

A fastening member 16 is loosely fit on an outer circumference of the small-diameter portion 14b. The fastening member 16 is fastened to the valve block 200 via non-illustrated bolts in a state where its inner circumferential portion is locked to the insertion portion 14a. The solenoid valve 100 is fixed to the valve block 200 by causing the fastening member 16 to be fastened to the valve block 200.

A part of the solenoid tube 14 whose outer circumference faces the coil 62 defines a plunger chamber 44 at its inner circumference. The plunger 33, a sub return spring 35, and a retainer 34 are arranged inside the plunger chamber 44 in this order, with the plunger 33 being closest to the insertion portion 14a. The sub return spring 35 is locked to the plunger 33 at one end, and locked to the retainer 34 at the other end. The sub return spring 35 pushes the plunger 33 in a direction of seating the sub poppet valve 27a on the sub seat 26d.

A stopper ring 37 is locked to an inner circumferential surface of the plunger chamber 44 near the insertion portion 14a. The stopper ring 37 is provided to prevent the plunger 33 from sliding out of the plunger chamber 44 when pushed back by the sub return spring 35 after the plunger 33 is installed inside the plunger chamber 44.

The plunger 33 has a cylindrical shape, and the sub valve 27 is fixed to its shaft center. The sub poppet valve 27a, which is provided on a tip of the sub valve 27, projects from an end portion of the plunger 33 toward the sub seat 26d so that it can be seated on the sub seat 26d.

The plunger 33 has a plurality of through holes 33a that penetrate the plunger 33 in the axial direction. The plunger chamber 44, in which the sub return spring 35 is disposed, communicates with the pilot pressure chamber 42 via the through holes 33a. Therefore, the pressure inside the plunger chamber 44 is equal to the pressure inside the pilot pressure chamber 42. A biasing force of the sub return spring 35 and the pressure inside the plunger chamber 44 act in a direction of pressing the sub poppet valve 27a toward the sub seat 26d.

An adjustment screw 36 is screwed to an end portion 14d of the solenoid tube 14 opposite to the insertion portion 14a so as to penetrate the end portion 14d in the axial direction. One end of the adjustment screw 36 is in contact with the retainer 34, which is slidably inserted in the plunger chamber 44. Therefore, rotation of the adjustment screw 36 changes a position of the retainer 34 in the axial direction, thereby changing the biasing force of the sub return spring 35. The other end of the adjustment screw 36 projects from the solenoid tube 14, and is covered by a cover 63 attached to the solenoid tube 14.

The operations of the solenoid valve 100 will now be described.

When current is not flowing through the coil 62, the plunger 33 is pressed by the biasing force of the sub return spring 35, the sub poppet valve 27a of the sub valve 27 is seated on the sub seat 26d, and the pilot pressure chamber 42 is in a closed state. Therefore, the pressure inside the pilot pressure chamber 42 is equal to the pressure of working oil supplied to the inlet passage 220, and the pressure equal to the pressure inside the inlet passage 220 acts on the valve-closing pressure receiving surface A2. In this case, the net force obtained from the thrust attributed to the pressure of working oil that is present inside the pilot pressure chamber 42 and acts on the valve-closing pressure receiving surface A2 and from the biasing force of the main return spring 24 exceeds the thrust attributed to the pressure of working oil that is supplied to the inlet passage 220 and acts on the valve-opening pressure receiving surface A1. As a result, the main valve 22 is pushed in a direction of closing the seat 13. Therefore, when current is not flowing through the coil 62, the solenoid valve 100 blocks the flow of working oil from the inlet passage 220 to the outlet passage 230.

On the other hand, when current is flowing through the coil 62, a thrust generated by the solenoid unit 60 causes the plunger 33 to overcome the biasing force of the sub return spring 35, and the plunger 33 is attracted toward the coil 62. As the sub valve 27 is displaced together with the plunger 33, the sub poppet valve 27a is separated from the sub seat 26d, and a gap is created between the sub poppet valve 27a and the sub seat 26d. Working oil inside the pilot pressure chamber 42 is discharged from this gap to the outlet passage 230 via the through hole 26c, the communication passage 23, and the communication holes 12b. Thus, working oil is discharged due to communication between the pilot pressure chamber 42 and the outlet passage 230. Meanwhile, the pressure inside the pilot pressure chamber 42 decreases because the orifice 242 limits the inflow of working oil to the pilot pressure chamber 42.

The main valve 22 is displaced in a direction of opening the seat 13 until the net force obtained from the thrust attributed to the pressure inside the pilot pressure chamber 42 acting on the valve-closing pressure receiving surface A2 and from the biasing force of the main return spring 24 comes into balance with the thrust attributed to the pressure inside the inlet passage 220 acting on the valve-opening pressure receiving surface A1. As a result, working oil is supplied from the inlet passage 220 to the outlet passage 230 by passing between the through holes 22d and the first seat portion 13a, between the poppet valve 22b and the second seat portion 13b, and through the communication holes 12b.

An increase in the current supplied to the coil 62 causes the sub poppet valve 27a to be further separated from the sub seat 26d. As a result, an amount of working oil discharged from the pilot pressure chamber 42 to the outlet passage 230 increases, and the pressure inside the pilot pressure chamber 42 further decreases. Along with such a decrease in the pressure inside the pilot pressure chamber 42, the main valve 22 moves further in the direction of opening the seat 13. This leads to an increase in the exposed opening areas of the through holes 22d of the spool valve 22a created by separation from the first seat portion 13a. Consequently, a flow rate of working oil supplied from the inlet passage 220 to the outlet passage 230 increases.

When current is stopped from flowing through the coil 62, the thrust that attracts the plunger 33 is dissolved, and thus the plunger 33 is pressed by the biasing force of the sub return spring 35. Then, the sub poppet valve 27a of the sub valve 27 is seated on the sub seat 26d, and the pilot pressure chamber 42 is closed. The pressure inside the closed pilot pressure chamber 42 increases to the point where it is equal to the pressure of working oil supplied to the inlet passage 220.

Once the pressure inside the pilot pressure chamber 42 has become equal to the pressure inside the inlet passage 220, the thrust attributed to the pressure inside the inlet passage 220 acting on the valve-opening pressure receiving surface A1 falls below the net force obtained from the thrust attributed to the pressure inside the pilot pressure chamber 42 acting on the valve-closing pressure receiving surface A2 and from the biasing force of the main return spring 24, as described above. Thus, the main valve 22 is pushed in the direction of closing the seat 13. As a result, the main valve 22 is displaced in the direction of closing the seat 13, and the flow of working oil from the inlet passage 220 to the outlet passage 230 is blocked.

The speed of closing the main valve 22 can be accelerated by setting an area of the valve-closing pressure receiving surface A2, on which the pressure inside the pilot pressure chamber 42 acts, to be larger than an area of the valve-opening pressure receiving surface A1, on which the pressure of working oil directed to the inlet passage 220 acts. This is because, in addition to the biasing force of the main return spring 24, the pressure inside the pilot pressure chamber 42 acting on a portion of the valve-closing pressure receiving surface A2 provided in excess of the valve-opening pressure receiving surface A1 acts as a force that presses the main valve 22 in the direction of closing the main valve 22.

Therefore, a flow rate of working oil supplied from the inlet passage 220 to the outlet passage 230 can be controlled by changing the pressure inside the pilot pressure chamber 42 through adjustment of current supplied to the coil 62.

Fixing of the solenoid valve 100 to the valve block 200 will now be described.

The solenoid valve 100 configured in the foregoing manner is inserted in the insertion hole 210 provided in the valve block 200 from the sleeve 12 side, and fixed by causing the fastening member 16 to be fastened to the valve block 200. The fastening member 16 is mounted on the small-diameter portion 14b of the solenoid tube 14.

In fastening the fastening member 16 to the valve block 200, a part of the fastening member 16 comes into contact with and presses the insertion portion 14a of the solenoid tube 14. Accordingly, the insertion portion 14a presses the large-diameter portion 12c of the sleeve 12, with which it is in contact via the flat end surface 14c, toward the step portion 211 of the insertion hole 210. That is, the solenoid valve 100 is fixed to the valve block 200 due to the insertion portion 14a and the large-diameter portion 12c being held between the step portion 211 and the fastening member 16.

The foregoing embodiment achieves the following functions and advantageous effects.

The sleeve 12 is fixed inside the insertion hole 210 by causing the large-diameter portion 12c to be pushed against the valve block 200 by the insertion portion 14a of the solenoid tube 14 from the open end of the insertion hole 210. The large-diameter portion 12c is closer to the open end of the insertion hole 210 than the slide support 12a and the seat 13 are. That is, as the sleeve 12 is not structurally fixed inside the insertion hole 210 by abutting a bottom portion of the insertion hole 210, an axial compressive force does not act on the slide support 12a and the seat 13 that are inserted deeper in the insertion hole 210 than the large-diameter portion 12c is. Therefore, the slide support 12a and the seat 13 are restrained from deformation caused by compressive stress. This can prevent the occurrence of operational defects, such as the inability of the main valve 22 that slides on the slide support 12a of the sleeve 12 to move smoothly, a decline in the sliding performance between the spool valve 22a and the first seat portion 13a, and a decline in the sealing performance between the poppet valve 22b and the second seat portion 13b.

When the solenoid valve 100 is used as a proportional control valve, smooth movement of the main valve 22 enables the main valve 22 to be displaced more accurately in response to a control signal. This can increase the precision of flow rate control.

The configurations, functions, and advantageous effects of the embodiment of the present invention will be collectively described below.

The solenoid valve 100 includes the main valve 22 that controls a flow rate of working oil flowing from the inlet passage 220 to the outlet passage 230 inside the valve block 200, the hollow cylindrical sleeve 12 in which the main valve 22 is slidably inserted, and the solenoid unit 60 that displaces the main valve 22 in the axial direction. The sleeve 12 includes the slide support 12a and the large-diameter portion 12c. The main valve 22 is slidably supported by the slide support 12a inside the insertion hole 210. The large-diameter portion 12c is closer to the open end of the insertion hole 210 than the slide support 12a is, and has a diameter larger than the outer diameter of the slide support 12a. The solenoid unit 60 is adjacent to the large-diameter portion 12c. The sleeve 12 is fixed inside the insertion hole 210 by causing the large-diameter portion 12c to be pushed against the valve block 200 by the solenoid unit 60.

With this configuration, the large-diameter portion 12c is located near the open end of the insertion hole 210, and the sleeve 12 is fixed inside the insertion hole 210 by causing the large-diameter portion 12c to be pushed against the valve block 200 by the solenoid unit 60. Accordingly, an axial compressive force does not act on the slide support 12a that is inserted deeper in the insertion hole 210 than the large-diameter portion 12c is. Therefore, the slide support 12a is restrained from deformation caused by compressive stress. This can prevent the occurrence of operational defects, such as the inability of the main valve 22 that slides inside the sleeve 12 to move smoothly.

The sleeve 12 further includes the seat 13 that allows the main valve 22 to be seated thereon, and the seat 13 is located at the side of the slide support 12a opposite to the large-diameter portion 12c.

With this configuration, the seat 13 that allows the main valve 22 to be seated thereon is located deeper inside the insertion hole 210 than the large-diameter portion 12c pushed against the valve block 200 is. Therefore, in fixing the sleeve 12 inside the insertion hole 210, an axial compressive force does not act on the seat 13. Accordingly, the seat 13 is restrained from deformation caused by compressive stress. This can prevent the occurrence of operational defects, such as a decline in the sliding performance between the spool valve 22a and the first seat portion 13a, and a decline in the sealing performance between the poppet valve 22b and the second seat portion 13b.

The solenoid unit 60 includes the cylindrical solenoid tube 14 connected to the sleeve 12, and the large-diameter portion 12c is pushed against the valve block 200 by causing the solenoid tube 14 to be fixed to the valve block 200.

With this configuration, the large-diameter portion 12c of the sleeve 12 is fixedly held between the step portion 211 of the valve block 200 and the insertion portion 14a of the solenoid tube 14. Such a simple configuration enables the sleeve 12 to be easily fixed inside the insertion hole 210.

A plane of contact between the flat end surface 14c of the solenoid tube 14 and the outer flat end surface 12d of the sleeve 12 functions as a seal portion sealing the pilot pressure chamber 42 serving as the space inside the sleeve 12.

With this configuration, as the large-diameter portion 12c of the sleeve 12 is fixedly held between the aforementioned portions, the outer flat end surface 12d of the sleeve 12 and the flat end surface 14c of the solenoid tube 14 are strongly pushed against each other. This increases adhesion between the outer flat end surface 12d and the flat end surface 14c, thereby forming the seal portion therebetween. This can prevent working oil inside the pilot pressure chamber 42 from leaking via the site of connection between the solenoid tube 14 and the sleeve 12, even without disposing a separate seal member at the site of connection.

The O-ring 53 is mounted on an outer circumference of the solenoid tube 14. The O-ring 53 is compressed between the solenoid tube 14 and the insertion hole 210, and seals a space inside the insertion hole 210.

With this configuration, the O-ring 53 disposed between the solenoid tube 14 and the insertion hole 210 seals the space inside the insertion hole 210. This can not only prevent working oil inside the insertion hole 210 from leaking to the outside, but also prevent external water, dust, and so forth from entering the interior of the insertion hole 210. Furthermore, as the entirety of the sleeve 12 is immersed in working oil, the sleeve 12 can be prevented from rusting.

The solenoid unit 60 further includes the fastening member 16 locked to the solenoid tube 14 at least partially, and fastened to the valve block 200. The solenoid tube 14 is fixed to valve block 200 by causing the fastening member 16 to be fastened to the valve block 200.

With this configuration, the large-diameter portion 12c of the sleeve 12 and the insertion portion 14a of the solenoid tube 14 are fixedly held between the step portion 211 of the valve block 200 and the fastening member 16. Such a simple configuration enables the sleeve 12 to be easily fixed inside the insertion hole 210.

Embodiments of the present invention were described above, but the above embodiments are merely examples of applications of the present invention, and the technical scope of the present invention is not limited to the specific constitutions of the above embodiments.

For example, in the foregoing embodiment, the solenoid valve 100 is fixed to the valve block 200 due to the insertion portion 14a and the large-diameter portion 12c being held between the step portion 211 and the fastening member 16. Alternatively, a male thread portion may be provided on an outer circumferential surface of the insertion portion 14a, and the insertion portion 14a may push the large-diameter portion 12c against the valve block 200 by being screwed to the insertion hole 210.

Alternatively, the fastening member 16 may be brought into direct contact with the outer flat end surface 12d of the large-diameter portion 12c without coming into contact with the insertion portion 14a, and push the large-diameter portion 12c against the valve block 200. In this case, the O-ring 53 on the outer circumference of the insertion portion 14a is disposed between the fastening member 16 and the insertion hole 210.

Any configuration may be adopted as long as the sleeve 12 is fixed inside the insertion hole 210 by causing the large-diameter portion 12c to be pushed against the valve block 200 as described above.

In the foregoing embodiment, the solenoid unit 60 indirectly displaces the main valve 22 by changing the pressure inside the pilot pressure chamber 42. Alternatively, the solenoid unit 60 may directly displace the main valve 22.

In the foregoing embodiment, the main valve 22 is provided with the spool valve 22a and the poppet valve 22b. Alternatively, the main valve 22 may be provided with only one of the spool valve 22a and the poppet valve 22b.

This application claims priority based on Japanese Patent Application No. 2015-141227 filed with the Japan Patent Office on Jul. 15, 2015, the entire contents of which are incorporated into this specification.

1. A solenoid valve fixedly inserted in an insertion hole provided in a valve block, the solenoid valve comprising:
a valve body configured to control a flow rate of a working fluid flowing through a passage provided inside the valve block;
a hollow cylindrical sleeve configured to allow the valve body to be slidably inserted therein; and
a solenoid unit configured to displace the valve body in an axial direction,
wherein
the sleeve includes a slide support and a large-diameter portion, the slide support being configured to slidably support the valve body, the large-diameter portion being provided so as to be closer to an open end of the insertion hole than the slide support and being configured to have a diameter larger than an outer diameter of the slide support,
the solenoid unit is adjacent to the large-diameter portion, and
the sleeve is fixed inside the insertion hole by causing the large-diameter portion to be pushed against the valve block by the solenoid unit.

2. The solenoid valve according to claim 1,
wherein
the sleeve further includes a seat configured to allow the valve body to be seated thereon, and
the seat is located at a side of the slide support opposite to the large-diameter portion.

3. The solenoid valve according to claim 1,
wherein
the solenoid unit includes a cylindrical solenoid tube connected to the sleeve, and
the large-diameter portion is pushed against the valve block by causing the solenoid tube to be fixed to the valve block.

4. The solenoid valve according to claim 3,
wherein
a plane of contact between the solenoid tube and the sleeve functions as a seal portion sealing a space inside the sleeve.

5. The solenoid valve according to claim 3,
wherein
the solenoid unit further includes a fastening member, the fastening member being locked to the solenoid tube at least partially and being fastened to the valve block, and
the solenoid tube is fixed to valve block by causing the fastening member to be fastened to the valve block.
